(19) United States
(12) Patent Application Publication
(10) Pub. No.: US 2007/0073911 A1
(43) Pub. Date: Mar. 29, 2007

(54) Data processing system, data processing apparatus and handling method

(75) Inventors: Munetoshi Eguchi, Tokyo (JP); Tomohiro Suzuki, Tokyo (JP); Yuji Tamura, Tokyo (JP); Tetsuya Ishikawa, Tokyo (JP); Hiroyasu Nishimura, Tokyo (JP); Tomoya Ogawa, Tokyo (JP); Fumikage Uchida, Asaka-shi (JP); Nao Moromizato, Tokyo (JP); Masayuki Yasukaga, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Konica Minolta Business Technologies, Inc.

(21) Appl. No.: 11/345,939

(22) Filed: Feb. 2, 2006

(30) Foreign Application Priority Data
Sep. 28, 2005 (JP) JP2005-282557

(51) Int. Cl. G06F 3/00

(52) U.S. Cl. 710/8

(57) ABSTRACT

To provide a system capable of avoiding an apparatus anomaly such as a system hang, even when an anomaly condition of connection in the cable connecting the apparatuses occurs. A first apparatus 10 in the transmission side includes: a data processing device 12; a buffer register 22 in which the processing device writes the data to be sent; a transmission section 23 for sending the data stored in the buffer register to a second apparatus 40 connected by a cable 3; and a loop detection section 27 for detecting an anomaly condition of connection in the cable during the data transmission. When detecting the anomaly condition of connection in the loop detection section, the first apparatus clears the buffer register to release the processing device from the data writing waiting, and at the same time the first apparatus notifies the processing device of the occurrence of the anomaly condition.

### RELATED APPLICATION

This application is based on Japanese Patent Application No. 2005-28557 filed on Sep. 28, 2005, in Japanese Patent Office, the entire content of which is hereby incorporated by reference.

### BACKGROUND

1. Field of the Invention

The present invention relates to a system, apparatus and method for carrying out data communication by connecting between apparatuses with a cable.

2. Description of the Related Art

In a system for exchanging data by connecting between a plurality of apparatuses with a cable, the data cannot be normally sent when the cable is disconnected or a connection failure occurs, so that the connection condition between the apparatuses is monitored to detect an anomaly condition of connection.

For example, in the case of connecting the apparatuses with a bundle of a plurality of connection lines, there is a method that assigns one of the plurality of connection lines for monitoring the connection condition between the apparatuses to detect an anomaly condition of connection based on the signal condition of the connection line (see, for example, Patent Document 1).

The data transmission between the apparatuses is generally carried out by a transmission section. When a CPU writes data to be sent in a buffer register or a FIFO (First-In First-Out) memory of the transmission section, the transmission section reads the data out of the buffer register or the FIFO memory and sends the data to the other machine (see, for example, Patent Document 2).

[Patent Document 1] Japanese Patent Publication Laid-Open No. HEI 8-107451

[Patent Document 2] Japanese Patent Publication Laid-Open No. HEI 5-28106

The buffer register of the transmission section is configured such that when the data is written therein, the next data writing is prohibited, and when the data transmission is terminated with the buffer register in an empty state, the next data writing is permitted. Generally, the next data writing is permitted upon completion of the transmission operation in the transmission side, regardless of whether or not the data reaches the other machine. Thus, although an anomaly condition is present in the cable connection, the writing prohibition to the buffer register is immediately removed.

However, for the purpose of ensuring reliable communication and other purposes, there is a transmission section having a configuration that sends the data within the buffer register to the other machine, and subsequently receives a data reception confirmation from the other machine, at the same time making the buffer register empty to permit the next data writing. In the case of using such a transmission section, when the cable is disconnected or disengaged during the transmission, the transmission section cannot receive the reception confirmation, so that the buffer register does not move to the empty state forever.

More specifically, as shown in FIG. 6, when the CPU writes the data to the buffer register in the empty state (P1), the buffer register turns “in use” (the writing prohibition state). Subsequently, when the cable is disconnected (P2), the reception confirmation does not arrive from the other machine and the “in use” state of the buffer register continues forever. Thus, with the next data to be sent, the CPU goes into an endless loop waiting for the next data writing to the buffer register (P3), which has been a factor to cause an abnormal operation of the entire apparatus controlled by the CPU. Particularly, when a system hang has occurred, the CPU has not been able to even notify a user about an occurrence of the anomaly condition.

### SUMMARY

The present invention is to solve the above described problem, and has an object to provide a data processing apparatus and system that are capable of avoiding an apparatus anomaly such as the system hang, even when an anomaly condition occurs in the connection condition of the cable connecting between the apparatuses, and a method for responding to an abnormal condition of cable connection.

The above object will be attained by the data processing system comprises

a first device which comprises a buffer register to store temporarily data to be transmitted and a transmission section to transmit the data stored in the buffer register, and

a second device connected to the first device via a cable;

wherein the first device further comprises

a detection section which detects an anomaly condition with regard to connection of the cable during data transmission from the first device to the second device,

a register clear section which clears the buffer register when the detection section detects the anomaly condition, and

a notification section which notifies an occurrence of the anomaly condition.

Further, the above object will be attained by the data processing apparatus comprises

a buffer register which temporally stores data to be transmitted;

a transmission section which transmits the data stored in the buffer register to a destination via a cable;

a detection section which detects an anomaly condition with regard to connection of the cable during the data transmission;

a register clear section which clears the buffer register when the detection section detects the anomaly condition, and

a notification section which notifies an occurrence of the anomaly condition.

Further, the above object will be attained by the handling method for detecting an anomaly condition with regard to a connection of a cable connected to a communication apparatus which includes a buffer register, a transmission section to transmit data stored in the buffer register to a destination, a transmission result confirmation section to receive a data reception confirmation from the destination, and a register clear section to clear the buffer register when the transmission result confirmation section receives the data reception confirmation from the destination, the handling method comprises the steps of:

detecting the anomaly condition with regard to the connection of the cable during the data transmission,

clearing the buffer register when the detection section detects the anomaly condition, and

notifying an occurrence of the anomaly condition.

The invention itself, together with further objects and attendant advantages, will best be understood by reference to the following detailed description taken in conjunction with the accompanying drawings.

### BRIEF DESCRIPTION OF THE DRAWINGS

FIG. 1 is a block diagram showing the configuration of a system composed of a first device and second device according to an embodiment of the present invention;

FIG. 2 is an illustration showing the flow of a transmission processing in the case of the normal condition of the cable connection;

FIG. 3 is an illustration showing the flow of a transmission processing in the case of an anomaly condition occurring in the cable connection;

FIG. 4 is an illustration showing the flow of the data in the case of an anomaly condition occurring in the cable connection;

FIG. 5 is a system configuration view in the case in which the first device is a multifunction machine and the second device is an external controller; and

FIG. 6 is an illustration showing the operation in the case of an anomaly condition occurring in the cable connection in a conventional apparatus.

In the following description, like parts are designated by like reference numbers throughout the several drawings.

### DETAILED DESCRIPTION OF THE PREFERRED EMBODIMENT

Hereinafter, the embodiment of the present invention will be described based on the drawings.

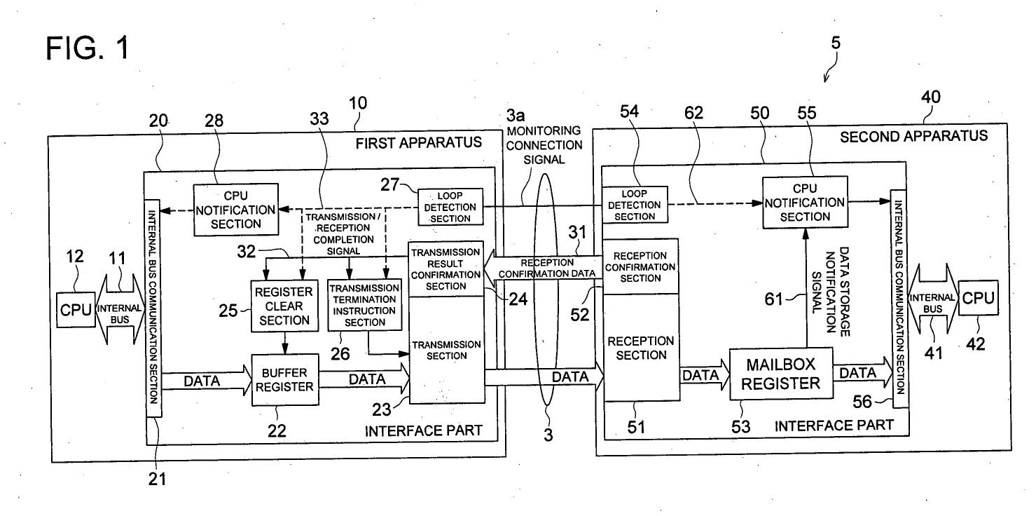

FIG. 1 shows the general configuration of a system 5 according to an embodiment of the invention. The system 5 is composed of a first apparatus 10 and second apparatus 40 that are data processing apparatuses respectively, and they are connected to each other by a cable 3 to allow them to carry out data communication.

The first apparatus 10 is composed of an internal bus 11 that is composed of a PCI bus and the like, a CPU 12 as the data processing device connected to the internal bus 11, and an interface part 20 also connected to the internal bus 11. A flash memory and an RAM, which are both not shown in the figure, are connected to the internal bus 11. The internal bus 11 may be further connected to a display unit, an operation section, and other devices.

The interface part 20 carries out a function of transmitting the data from the first apparatus 10 to the second apparatus 40. The interface part 20 includes: an internal bus communication section 21 for communicating with the CPU 12 and other modules via the internal bus 11; a buffer register 22 for temporarily storing the data to be sent; a transmission section 23 for sending the data stored in the buffer register 22 to the second apparatus 40 connected by the cable 3; a transmission result confirmation section 24 for receiving a data reception confirmation from the second apparatus 40; a register clear section 25 for clearing the buffer register 22; a transmission termination instruction section 26 for instructing the transmission section 23 to stop the transmission; a loop detection section 27 as a detection section for detecting an anomaly of connection in the cable 3; and a CPU notification section 28 for notifying the CPU 12 of the occurrence of the anomaly of connection that the loop detection section 27 has detected.

More specifically, the buffer register 22 is connected to the internal bus communication section 21, in which the data is written from the CPU 12 through the internal bus 11 and the internal bus communication section 21. The transmission result confirmation section 24, when receiving a reception confirmation data 31 from the second apparatus 40, outputs a transmission/reception completion signal 32 to the register clear section 25 and to the transmission termination instruction section 26.

Upon the input of the transmission/reception completion signal 32, the register clear section 25 clears the buffer register 22. Upon the input of the transmission/reception completion signal 32, the transmission termination instruction section 26 instructs the transmission section 23 to terminate the data transmission. Thus, in the normal condition, when data is written to the buffer register 22 by the CPU 12, the data is sent to the second apparatus 40 by the transmission section 23, and then the register clear section 25 operates so as to clear the buffer register 22 at a time when receiving the reception confirmation data 31 from the second apparatus 40. At this time, during a period of time when the data is written in the buffer register 22 until the buffer register 22 is cleared, the apparatus is designed to prohibit the next data writing to the buffer register 22.

The cable 3 is made of a plurality of connection lines, and one connection line 3a is a connection line dedicated for monitoring the condition of the connection with the second apparatus 40. The loop detection section 27 detects an anomaly of connection in the cable 3 by monitoring, the state of the signal (connection monitoring signal) of the connection line 3a. Herein, the connection monitoring signal is a DC voltage signal with a certain voltage. It is allowable to use a clock signal and other signals as the connection monitoring signal. The loop detection section 27 also detects, in addition to the poor connection and disconnection of the cable 3, the power-off of the second apparatus 40 as the anomaly of connection.

During the occurrence of the anomaly of connection, the loop detection section 27 outputs an anomaly detection signal 33 to the register clear section 25, the transmission termination instruction section 26, and the CPU notification section 28. Upon the input of the anomaly detection signal 33, the register clear section 25 clears the buffer register 22. Upon the input of the anomaly detection signal 33, the transmission termination instruction section 26 instructs the transmission section 23 to terminate the data transmission. Upon the input of the anomaly detection signal 33, the CPU notification section 28 outputs an interrupt signal indicating the occurrence of the anomaly of connection to the CPU 12.

It is to be noted that the function as the transmission section is achieved by the internal bus transmission section 21, the buffer register 22, the transmission section 23, the transmission result confirmation section 24, and the register clear section 25.

The second apparatus 40 is composed of an internal bus 41 that is composed of a PCI bus and the like, a CPU 42 connected to the internal bus 41, and an interface part 50 also connected to the internal bus 41. A flash memory and an RAM, which are both not shown in the figure, is connected to the internal bus 41. The internal bus 41 may be further connected with a display unit, an operation section and other devices.

The interface part 50 includes: a reception section 51 for receiving data sent from the transmission section 23 of the first apparatus 10 through the cable 3; a reception confirmation section 52 for confirming an error of the data which the reception section 51 has received, and when confirming that the error is absent, sending the reception confirmation data 31 to the transmission result confirmation section 24 of the first apparatus 10; a mailbox register 53 for temporarily storing the data which the reception section 51 has received; a loop detection section 54 for detecting the anomaly of connection in the cable 3; a CPU notification section 55 for carrying out the function of notifying the CPU 42 of the anomaly of connection that the loop detection section 54 has detected and the function of notifying the CPU 42 that the data is stored in the mailbox register 53; and an internal bus communication section 56 for communicating with the CPU 42 and other modules via the internal bus 41.

More specifically, the reception confirmation section 52 carries out a CRC (Cyclic Redundancy Check) check and parity check of the data which the reception section 51 has received, and sends the reception confirmation data 31 when the error is absent. The data that the reception section 51 has received is confirmed to have no error by the reception confirmation section 52, and then is stored in the mailbox register 53.

The mailbox register 53 with the data stored therein outputs a data storage notification signal 61 to the CPU notification section 55. The CPU notification section 55 having received the data storage notification signal 61 outputs a predetermined interrupt signal to the CPU 42. The data stored in the mailbox register 53 is read out of the mailbox register 53 by the read-out instruction from the CPU 42, and the data is output to the CPU 42 through the internal bus communication section 56 and the internal bus 41. During the occurrence of the anomaly of connection in the cable 3, the loop detection section 54 outputs an anomaly detection signal 62 to the CPU notification section 55. The CPU notification section 55 is designed to output the interrupt signal indicating the occurrence of the anomaly of connection to the CPU 42, when the anomaly detection signal 62 is input therein.

Next, the description will be made about the transmission operation in the case in which the cable 3 is normally connected.

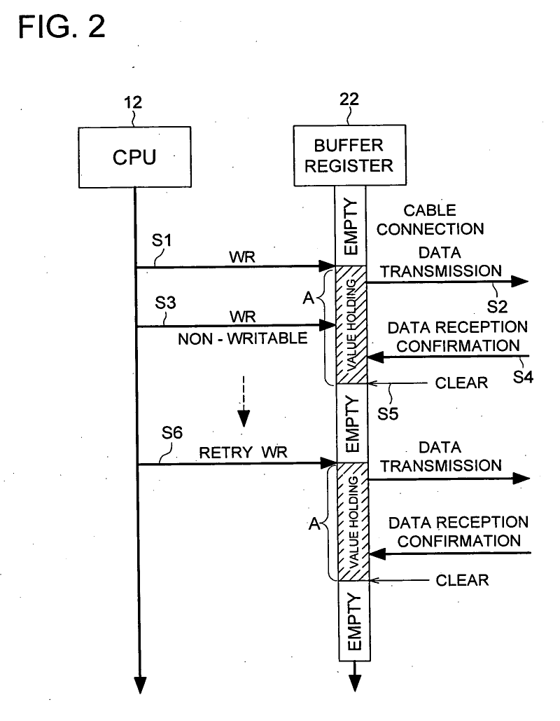

FIG. 2 shows the flow of the transmission processing in the case of the normal condition of connection in the cable 3. The flow of the data in the normal condition is shown in FIG. 1. Incidentally, in FIG. 1, the signals that are not output in the normal condition are indicated by dashed lines. The CPU 12 of the first apparatus 10 confirms that the buffer register 22 is in the empty state, and then writes the data in the buffer register 22 of the interface part 20 (S1). The transmission section 23 detects the presence of the data to be sent to the buffer register 22, and sends the data to the reception section 51 of the second apparatus 40 through the cable 3 (S2).

The buffer register 22 becomes the value holding state with the data written therein, and during a period of time when this state continues, the writing of the next data to the buffer register 22 from the CPU 12 is prohibited (S3).

The reception section 51 of the second apparatus 40 receives the data sent from the transmission section 23 of the first apparatus 10, and the reception confirmation section 52 confirms the presence or absence of an error in the data. When confirming that the error is absent, the reception confirmation section 52 of the second apparatus 40 sends the reception confirmation data 31 to the transmission result confirmation section 24 of the first apparatus 10 (S4). Also, when the absence of the error is confirmed, the data the reception section 51 has received is stored in the mailbox register 53.

When the data is stored in the mailbox register 53, the data storage notification signal 61 is output to the CPU notification section 55. The CPU notification section 55 having received this signal outputs a predetermined interrupt signal to the CPU 42. The CPU 42 detects that the data is stored in the mailbox register 53 by the interrupt signal from the CPU notification section 55, and reads the data out of the mailbox register 53.

The transmission result confirmation section 24 of the first apparatus 10 receives the reception confirmation data 31 from the reception confirmation section 52 of the second apparatus 40, and then outputs the transmission/reception completion signal 32. Thereby, the transmission termination instruction section 26 instructs the transmission section 23 to terminate the data transmission, and the transmission section 23 terminates the data transmission in response to the instruction. Further, the register clear section 25 having received the transmission/reception completion signal 32 clears the buffer register 22 to make it empty (S5).

Because of this feature, the data writing to the buffer register 22 is permitted, so that the CPU 12 writes the next data in the buffer register 22 (S6). In other words, the next data writing to the buffer register 22 is rejected during a period of time when the data is written to the buffer register 22 until the buffer register 22 is cleared upon the reception of the reception confirmation data 31 (period A in the figure), while the CPU 12 is retrying the operation of writing the next data. Then, when the buffer register 22 is cleared and the next data writing is permitted, the CPU 12 succeeds in the retrial and the next data is written. In the case of the normal condition of connection in the cable 3, such a series of operations is repeatedly carried out according to the necessity.

Next, the description will be made about the transmission operation in the case of an anomaly occurring in the connection of the cable 3.

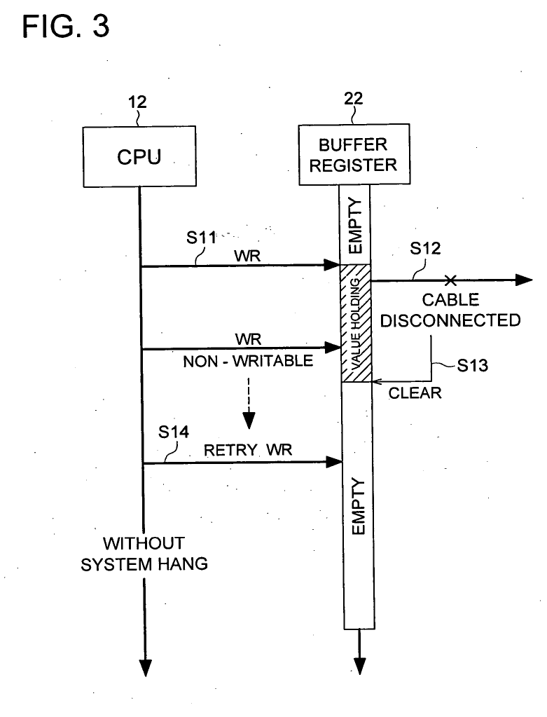

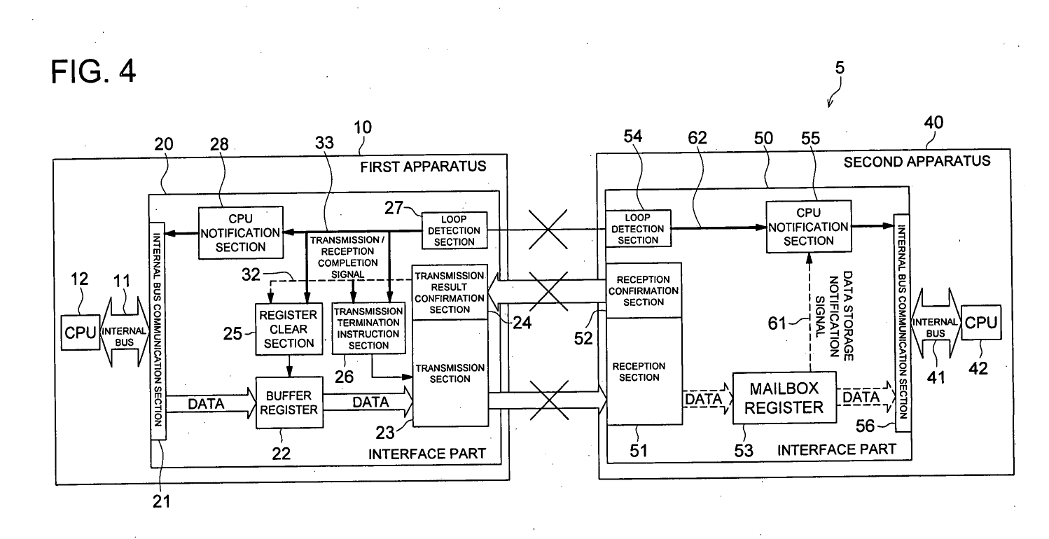

FIG. 3 shows the flow of the transmission processing in the case of an anomaly occurring in the connection of the cable 3, and FIG. 4 shows the flow of the data in this time. Incidentally, in FIG. 4, the signals that are not output in the anomaly occurrence are indicted by dashed lines. The CPU 12 of the first apparatus 10 confirms that the buffer register 22 is in the empty state, and then writes the data in the buffer register 22 of the interface part 20 (S11). The transmission section 23 detects the presence of the data to be sent to the buffer register 22, and then sends the data to the reception section 51 of the second apparatus 40 through the cable 3, and at the time a disconnection of the cable 3 occurs (S12).

The loop detection section 27 detects the disconnection of the cable 3, and outputs the anomaly detection signal 33 to the transmission/reception completion signal 32, the transmission termination instruction section 26, and the CPU notification section 28. Thereby, the transmission termination instruction section 26 instructs the transmission section 23 to terminate the transmission, and the transmission section 23 terminates the data transmission operation in response to the instruction. The register clear section 25 having received the anomaly detection signal 33 clears the buffer register 22 to make it empty (S13). Further, the CPU notification section 28 having received the anomaly detection signal 33 outputs the interrupt signal indicating the disconnection of the cable 3 to the CPU 12 to notify it of the occurrence of the anomaly.

In the case in which the disconnection of cable 3 or other related failures occurs, as shown in FIG. 4, the reception confirmation data 31 is not received from the reception confirmation section 52, so that the buffer register 22 is not cleared and the value holding state continues forever, unless the anomaly is detected and the above described steps are carried out. As a result, the CPU 12 continues to retry the operation of writing the next data, causing such a trouble that the system hangs.

However, the system 5 of the present embodiment is designed to detect the disconnection of the cable 3 and then to clear the buffer register 22, so that the CPU 12 succeeds in the retrial (S14) to complete the operation of writing the next data, thereby such an event as system hang can be avoided.

Further, the system 5 is designed to notify the CPU 12 of the occurrence of the anomaly of connection, so that the CPU 12 can stop the operation of further writing the data to carry out an error display or other operations. It is also designed to instruct the transmission section 23 to stop the transmission, so that the execution of unnecessary transmission operation by the transmission section 23 can be avoided.

Although the notification to the CPU 12 and the clear of the buffer register 22 may be carried out in any order, it is preferable that after the CPU 12 having received the notification about the anomaly occurrence stops the data writing operation, the clear is carried out at least once to the buffer register 22. For example, the clear of the buffer register 22 is preferably continued during a period of time when the loop detection section 27 detects the anomaly of connection in the cable 3. Incidentally, for the avoidance of the system hang, the transmission stop instruction to the transmission section 23 is not required, but at least the clear of the buffer register 22 and the notification of the anomaly occurrence to the CPU 12 are required to be carried out.

As shown in FIG. 4, when an anomaly occurs in the connection of the cable 3, the second apparatus 40 in the reception side operates as follows. The loop detection section 54 detects an anomaly of connection in the cable 3 to output the anomaly detection signal 62, and the CPU notification section 55 having received the anomaly detection signal 62 outputs the predetermined interrupt signal to the CPU 42. The CPU 42 that detects the occurrence of an anomaly such as the disconnection or disengagement of the cable 3 by this interrupt signal carries out an error display and the like.

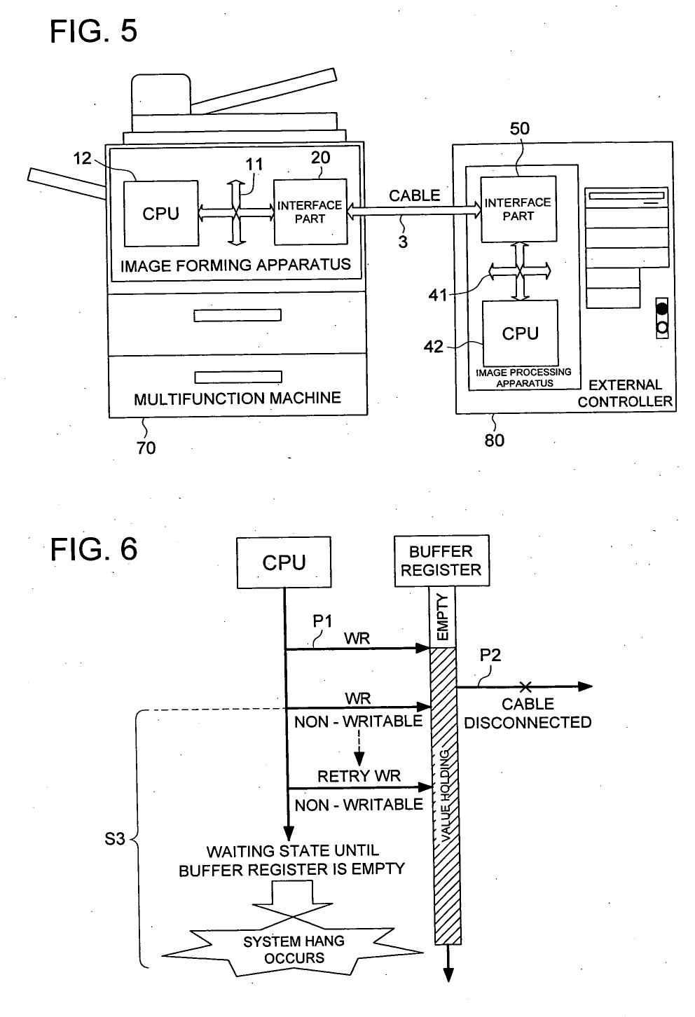

As a specific example of the system 5, FIG. 5 shows the system configuration in the case in which the first apparatus 10 is a multifunction machine (multi function peripheral) 70 and the second apparatus 40 is an external controller (print controller) 80. The multifunction machine 70 is an image forming apparatus including such functions as a copy function of reading an image of a document to form the image and output the duplication thereof onto a recording paper, a scanner function of sending the image data obtained by reading the document to the external apparatus, and a printer function of receiving the print data to print it onto the recording paper, the multifunction machine 70 further includes a document reader, a printer section and the like.

The external controller 80 is an image processing apparatus having a function of converting the print data represented by code data into the raster image, and a function of storing the input image data and applying the image processing thereto. The external controller 80 may be a dedicated apparatus or a personal computer and the like.

In this example, in addition to the various control data, large volume image data is also sent and received between the multifunction machine 70 and the external controller 80. For example, in the case of sending and storing a large number of sheets of image data that has been read by the multifunction machine 70 to the external controller 86, and when the cable 3 is disengaged, the conventional system may sometimes hang up. When the system hangs, the display section and the operation section are both not available, so that it is impossible to carry out the error display or to issue any instruction to the user in order to recover the system. Incidentally, in the present embodiment, the system configuration is illustrated assuming that the first apparatus 10 is the multifunction machine 70 and the second apparatus 40 is the external controller 80. However, another system configuration is allowable in which the first apparatus 10 is the external controller 80 and the second apparatus 40 is the multifunction machine 70. The either system configuration is applicable as long as the apparatus in the data transmission side has the buffer register for storing the data to be sent and the register clear section for clearing the buffer register.

In this embodiment, the system hang can be avoided by detecting the anomaly of connection in the cable 3, clearing the buffer register 22 and notifying the anomaly occurrence to the CPU 12, so that the multifunction machine 70 and the external controller 80 can appropriately guide the user using the display unit and the like to promote the recovery of the apparatuses. For example, the multifunction machine 70 and the external controller 80 can issue such instructions to turn the system power ON/OFF and to confirm the attachment of the cable 3. Incidentally, in the invention, the anomaly of connection in the cable should include not only the disconnection, but also the state in which the cable is disengaged by itself.

Having described the preferred embodiment of the invention with reference to the accompanying drawings, it is to be understood that the specific configuration is not limited to those illustrated in the embodiment and that various changes and additions could be included therein without departing from the sprit and scope of the invention.

For example, in the example of FIG. 1, the system includes the interface part 20 and interface part 50 for sending the data from the first apparatus 10 to the second apparatus 40. However, in order to realize the two-way data transmission/reception, the system may be configured such that the second apparatus 40 is provided with the same circuit as that of the interface part 20 and the interface part 20 is provided with the same circuit as that of the interface part 50 respectively, and these are connected by a cable to realize the communication in the reverse direction.

Further, as the memory for temporarily storing the data, the case using the buffer register 22 was exemplified in the embodiment, but the FIFO memory and the like may be used therein.

Further, in the embodiment, the buffer register 22 is cleared by the register clear section 25, but the configuration is allowable in which the interface part 20 carries out the reset operation by itself based on the output of the anomaly detection signal 33.

Further, the clear operation of the buffer register 22 in the anomaly detection may also be configured to continue until receiving the predetermined confirmation signal from the CPU 12. In other words, the CPU 12 having recognized the anomaly of connection by the notification from the CPU notification section 28 stops the operation of writing the data to the buffer register 22 and then outputs the confirmation signal to the interface part 20, which allows the CPU 12 to avoid going into the endless loop waiting for the next data writing to the buffer register 22 without fail.

According to the preferred embodiment of the present invention, clearing the buffer register allows the next data writing, thereby enabling a processing device, such as a CPU that carries out the storage processing of the data to be sent to the buffer register, to avoid going into the endless loop waiting for the next data writing to the buffer register. Further, notifying the processing device about the anomaly condition of connection in the cable allows the processing device to stop the operation of further writing the data to the buffer register. Incidentally, it is preferable to continue clearing the buffer register during the anomaly detection.

According to another aspect of the preferred embodiment of the present invention, the cable is a bundle of connection lines for the data transmission between the apparatuses, such as a cable for bridging an internal bus of a certain terminal and an internal bus of another terminal, and a specific example thereof includes cables in PCI (Peripheral Component Interconnect) Express.

According to another aspect of the preferred embodiment of the present invention, clearing the buffer register allows the next data writing. Further, notifying the processing device such as a CPU about the anomaly condition of connection in the cable allows the processing device to stop the data writing operation to the buffer register, thereby enabling it to avoid a trouble such that the data processing device hangs in an endless loop waiting for the next data writing to the buffer register. Incidentally, the clear of the buffer register may be carried out by such a method that resets the entire communication section.

According to another aspect of the preferred embodiment of the present invention, when the transmission is not completed due to the anomaly condition, the system terminates the state in which the transmission of the data stored in the buffer register is retried many times.

According to another aspect of the preferred embodiment of the present invention, although the one connection line to be monitored may be a connection line for sending the data, with a connection line dedicated for monitoring, the anomaly condition of connection can be detected without depending on the content of the data (for example, a succession of 0s).

According to another aspect of the preferred embodiment of the present invention, the first device in the transmission side is, for example, an image forming apparatus such as a digital copier or a multifunction machine, and the second device in the reception side is, for example, an external controller (image processing apparatus) such as a print controller or a personal computer.

According to another aspect of the preferred embodiment of the present invention, the first device in the transmission side is, for example, an external controller (image processing apparatus) such as a print controller or a personal computer, and the second device in the reception side is, for example, an image forming apparatus such as a digital copier or a multifunction machine.

According to another aspect of the preferred embodiment of the present invention, it terminates the repeated operation of further sending the data stored in the buffer register to the other machine, as the data transmission is not completed due to the anomaly condition.

According to another aspect of the preferred embodiment of the present invention, because the system, data processing apparatus, and method for responding to abnormal condition of cable connection according to the embodiment of the present invention, monitor the anomaly condition of connection in the cable during transmission, and when detecting an anomaly condition, clear the buffer register for storing the data to be sent, at the same time notify an occurrence of the anomaly condition to the processing device such as the CPU, so that although the anomaly condition occurs in the connection of the cable between the apparatuses, the processing device will never go into the endless loop waiting for the next data writing to the buffer register, thereby the occurrence of the apparatus anomaly such as the system hang can be avoided.

It is to be noted that various changes and modifications will be apparent to those skilled in the art. Therefore, unless such changes and modifications depart from the scope of the present invention, they should be construed as being included therein.

What is claimed is:

1. A data processing system, comprising:
a first device which comprises a buffer register to store temporarily data to be transmitted and a transmission section to transmit the data stored in the buffer register, and
a second device connected to the first device via a cable;
wherein the first device further comprises
a detection section which detects an anomaly condition with regard to connection of the cable during data transmission from the first device to the second device,
a register clear section which clears the buffer register when the detection section detects the anomaly condition, and
a notification section which notifies an occurrence of the anomaly condition.

2. The data processing system of claim 1, wherein the data transmission from the first device to the second device is terminated when the detection section detects the anomaly condition.

3. The data processing system of claim 1, wherein the cable includes a plurality of connection lines and the detection section detects the anomaly condition by using one of the connection lines.

4. The data processing system of claim 1, wherein the first device is an image forming apparatus and the second device is an external controller.

5. The data processing system of claim 1, wherein the first device is, an external controller and the second device is an image forming apparatus.

6. A data processing apparatus, comprising:
a buffer register which temporally stores data to be transmitted;
a transmission section which transmits the data stored in the buffer register to a destination via a cable;
a detection section which detects an anomaly condition with regard to connection of the cable during the data transmission;
a register clear section which clears the buffer register when the detection section detects the anomaly condition, and
a notification section which notifies an occurrence of the anomaly condition.

7. The data processing apparatus of claim 6, further comprising:
a transmission termination section which terminates the data transmission when the detection section detects the anomaly condition.

8. The data processing apparatus of claim 6, wherein the cable includes a plurality of connection lines and the detection section detects the anomaly condition by using one of the plurality of connection lines.

9. The data processing apparatus of claim 6, further comprising:
a transmission result confirmation section which receives a data reception confirmation from the destination, wherein the register clear section clears the buffer register when the transmission result confirmation section receives the data reception confirmation from the destination.

10. A handling method for detecting an anomaly condition with regard to a connection of a cable connected to a communication apparatus which includes a buffer register, a transmission section to transmit data stored in the buffer register to a destination, a transmission result confirmation section to receive a data reception confirmation from the destination, and a register clear section to clear the buffer register when the transmission result confirmation section receives the data reception confirmation from the destination, the handling method comprising the steps of:
detecting the anomaly condition with regard to the connection of the cable during the data transmission,
clearing the buffer register when the detection section detects the anomaly condition, and
notifying an occurrence of the anomaly condition.
